(19) United States
(12) Patent Application Publication
(10) Pub. No.: US 2006/0185698 A1
(43) Pub. Date: Aug. 24, 2006

(54) Holding device for glasses

(76) Inventor: Rainer Adasch, Hannover (DE)

Correspondence Address: WILLIAM COLLARD;COLLARD & ROE, P.C., 1077 NORTHERN BOULEVARD, ROSLYN, NY, 11576, US

(21) Appl. No.: 11/064,768

(22) Filed: Feb. 24, 2005

(51) Int. Cl. B08B 3/02

(52) U.S. Cl. 134/135; 134/200; 134/201

(57) ABSTRACT

The present invention provides a holding device for glasses for use in a dishwasher, having a base plate (1) with holding recesses (2) for receiving stems of glasses and which can be positioned by means of carrier rods (10) in a distance to a basket for dishes. The base plate (1) can be formed rectangularly, but preferentially circularly, especially preferred ring-shaped. The holding recesses are arranged on the outer rim of the base plate (1) and are not closed but are open to the circumferential rim of the base plate.

The present invention relates to a holding device for dishes, especially for glasses, which can be arranged in a dishwasher.

It is known to arrange dishes and glasses in wire baskets in dishwashers so that dishwater can be injected into the glasses from below and can drain freely by gravitation. It is also known to provide holding devices of synthetic material, hinged at the wire basket, which can be tilted into the horizontal if necessary and which then have unilaterally open recesses from which glasses can be suspended by their stems. The known devices hold glasses at their stems such that an approximately horizontally oriented or slightly inclined plane provides a recess, into which the vertically oriented stems of the glass can be inserted sideways.

Generic holders for glasses in dishwashers have the disadvantage that long glasses cannot be held safely and especially glasses having a large diameter of their foot region, e.g. glasses for wheat beer, cannot be inserted into the provided holder openings of the rinsing basket.

From DE 200 05 725 U1 a device for suspending and holding long-footed wine glasses and champagne glasses is known, consisting of a stretched plate having a perpendicularly and centrally attached holding stem. On its two opposite ends, the plate provides a circular catching recess for receiving the stem of a glass, which is accessible from the quoin of the base plate by an access region having a smaller diameter than the diameter of the catching recess.

In contrast to the known device it is the problem to the present invention to provide a holding device for glasses, whose catching recesses are arranged in an alternative design.

It is a further problem to the invention, to provide a holding device for glasses, which can be inserted into a number of different dishwasher baskets by simple means and which can be fastened to and released from the dishwasher basket in a simple manner.

The holding device according to the invention for glasses for use in a dishwasher comprises a base plate, providing catching recesses for receiving stems of glasses and which can be positioned by means of carrier rods in a distance to a basket for dishes. The base plate can be formed rectangularly, but preferably circularly, especially preferred ring-shaped, and provides catching recesses on its outer rim, which are not closed, but which are open to the circumferential edge of the base plate in an access region.

Parts of dinnerware, e.g. glasses, can be inserted into the catching recess with their stem, which is oriented perpendicularly to the plane of the base plate. Preferably, the catching recesses are C-shaped, like e.g. in the form of a proportionate circle. The catching recesses are shaped such that their access region, which is carried through the plane of the base plate, has a smaller inner width than their diameter. In this way it is ensured that a glass can be inserted into the catching recess within the plane of the base plate, but this then kept secure within the catching recess.

In a further embodiment, the C-shaped holding recesses are not arranged immediately adjacent the circumferential edge of the base plate but are set back from the edge of the base plate a bit into the plane of the base plate and behind its outer circumferential line, respectively, wherein the opening of the holding recess is accessible from the circumferential line of the base plate by an entrance canal. This entrance canal has the shape of a straight slot in the shape of two opposite, essentially parallel edge regions, connecting the circumferential line of the base plate with the holding recess. This entrance canal at least in one region has a smaller inner width than the diameter of the holding recess, preferentially adjacent the C-shaped holding recess.

It is especially preferred that the holding recesses have at least one edge in the shape of a bevel so that the suspended glass with its foot lies on this bevel of the holding recess.

For holding of the base plate in a distance from the bottom of the device, which is typically used for receiving the dishes within a dishwasher, e.g. a basket for dishes, carrier rods are arranged between the base plate and the basket for dishes.

For holding of the carrier rods, the base plate according to the invention in a first embodiment on its bottom site provides openings, preferentially cylindrical, or borings, into which first end regions of the carrier rods can be introduced having frictional connection or positive fit. These openings, which are also termed supporting recesses, can be cylindrical, preferentially slightly conically narrowing, are shaped in the form of a simple ring. Carrier rods can be inserted with their first end into the supporting recesses, wherein the diameters of supporting recess and first end of the carrier rod are to be dimensioned such that a secure clamping, i.e. frictional fit connection is achieved. It is also possible to provide at least one of the supporting recess or of the first end of the carrier rod with a thread to produce an intense connection between carrier rod and supporting recess. The carrier rods are secured with their second opposite end to the dishwasher basket, e.g. clamped to struts of a basket for dishes by circular recesses, which are formed onto resilient elements. Preferentially, the resilient elements on the second end of the carrier rods have a wedge-shaped recess, which in the shape of a funnel transforms into in at least partially circular region having a slightly larger diameter. The funnel-shaped region of the second end of the carrier rods is formed therein by two opposing resilient arms, which can be shaped from the material of the carrier rods.

In a further embodiment, the holding device according to the invention can also be fixed within a dishwasher by hanging rods instead of carrier rods, wherein such hanging rods engage the base plate with frictional connection or with positive fit from the direction of its upper side. Such hanging rods are then connected with their first ends to the base plate. Second ends of such hanging rods are connected to a region of the dishwasher positioned above the base plate, e.g. by hooks, e.g. they are suspended from below to struts of an upper basket for dishes.

The material for the base plate preferentially is a heat-resistant and detergent resistant synthetic material, e.g. styrene acrylic nitrile or PVC or stainless metal or metal coated with synthetic material.

In the case of using synthetic material as the material for the base plate, it can be manufactured including the holding recesses, entrance canals to the holding recesses, optionally having a bevel at the holding recesses in the direction of the upper side of the base plate, as well as supporting recesses on the lower side of the base plate including supporting ribs by a die moulding process.

Therein, the base plate may have a closed upper-side surface, preferentially a plane surface, to let rinsing water drain off.

For strengthening of mechanical stability, the base plate can be provided on its lower side with supporting ribs, or have a sufficient strength.

Alternatively, the circumferential regions of the holding recesses, optionally with the adjacent entrance canals in the form of a straight slot, as well as the circumferential line of a base plate and the circumferential lines of supporting recesses can be formed from rod-shaped metal elements, preferentially from wire, e.g. with a diameter of 2 to 5 mm, wherein all design elements, which the base plate provides, are connected to each other with sufficient mechanical stability.

In an especially preferred embodiment, the base plate in total is circular and has a circular central opening. When holding the base plate by means of the carrier rods within a basket for dishes, the circular central opening can also serve for holding a very high vessel, introduced therein, e.g. for a very long glass, or may also be provided with holding recesses, which are accessible from the central opening of the base plate.

### SHORT DESCRIPTION OF THE FIGURES

The present invention will now be explained with reference to the attached drawings, wherein

FIG. 1 shows a holding device according to the invention in schematic top view,

FIG. 2 shows a holding device according to the invention in perspective view in sections from its upper side,

FIG. 3 shows a holding device according to the invention in sections from its lower side in perspective view,

FIG. 4 shows a holding device according to the invention in section A-A of FIG. 1,

FIG. 5 shows a carrier rod in the perspective side view,

FIG. 6 shows a carrier rod in side view,

FIG. 7 shows a detailed view of the first end of a carrier rod and

FIG. 8 shows a detailed view of the second end of a carrier rod.

In the figures, identical reference numerals refer to identical elements.

### DETAILED DESCRIPTION OF THE FIGURES

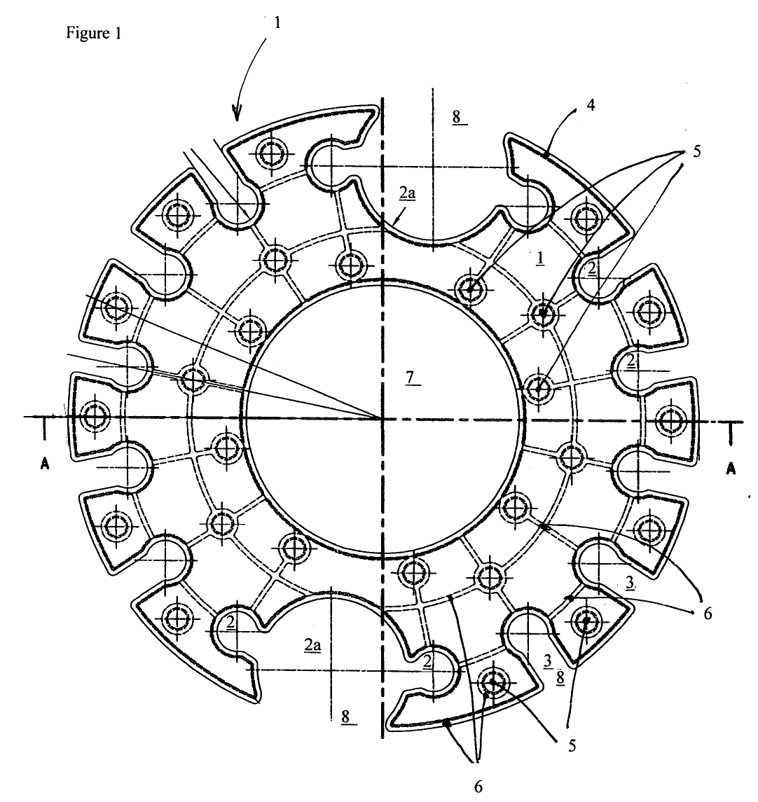

In FIG. 1, a base plate 1 is depicted, having holding recesses 2. The holding recesses 2 have a C-shaped cross-section and remove a portion of the area of the base plate in the shape of a proportional circle, wherein the holding recesses 2 are accessible from the rim of the base plate 1 within its plane by an access region 8. The access regions 8 of holding recesses 2, 2a within the plane of the base plate have a smaller inner width than the diameter of the holding recesses 2, 2a. The holding recess 2a has a larger diameter than holding recesses 2 that are branching off therefrom. The holding recesses 2 are then accessible through the holding recess 2a, when no glass having a large foot diameter is arranged therein, so that instead of one glass having a large foot diameter in holding recess 2a, two glasses having smaller foot diameters can be held in adjacent holding recesses 2. The holding recesses 2, 2a have entrance canals 3, which are formed in the form of a straight slot with opposite parallel edges. These access canals 3 extend the access regions 8 of the holding recesses 32 in the plane of the base plate to its circumferential line.

The supporting recesses 5 are distributed in the form of circular borings over base plate 1. It is preferred that a multitude of supporting recesses 5 are each arranged on concentric cycles, in identical distances on the base plate. In this way it is possible to insert a smaller number of carrier rods into supporting recesses 5 to be selected such that the position of the carrier rods can be chosen freely, but still a sufficient number of carrier openings 5 is provided to allow an essentially parallel arrangement of the base plate to a plane of a dishwasher, each time using equally long carrier rods. It is especially preferred that the supporting recesses 5 are connected to each other by supporting ribs 6, and also that the circumferential lines of holding recesses 2, 2a of the base plate 1 and of entrance canals 3 are strengthened in their edge regions, to also adopt the shape of supporting ribs 6.

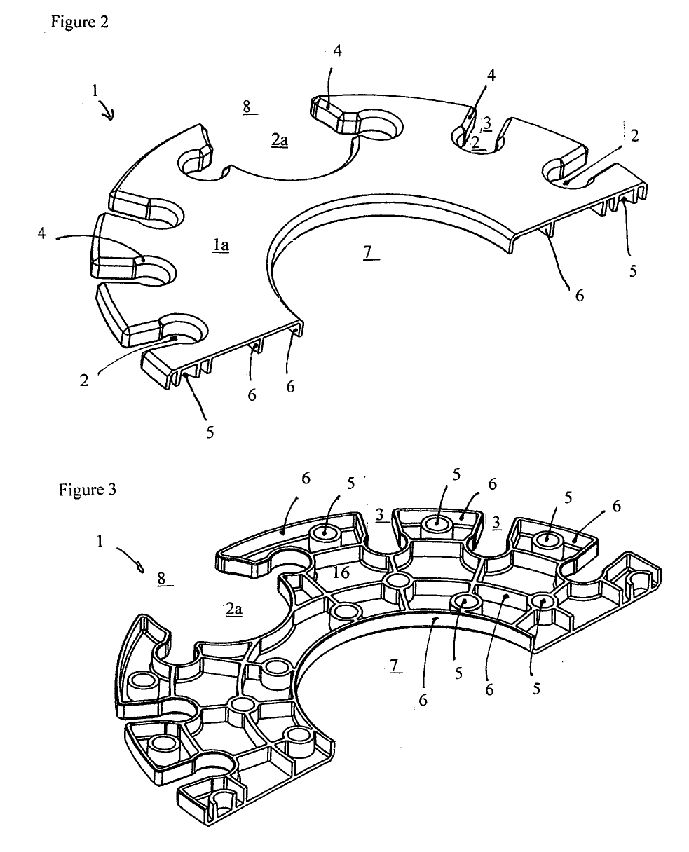

It is shown in FIG. 2 that both the circumferential lines of the base plate 1 and the holding recesses 2, 2a and their entrance canals 3 have a bevel 4 on the upper side of the base plate. The bevel 4 serves to provide a contact region for the feet of glasses so that these need not lie on a sharp edge. The upper side of base plate 1 is formed as a plane and closed surface, so that rinsing water can drain cleanly. The supporting ribs 6 are arranged on the lower side of base plate 1. The central opening 7 also has a bevel 4.

FIG. 3 shows the base plate 1 from its lower side 1b, wherein in perspective presentation it becomes clear that also the rim regions of base plate 1, of holding recesses 2, 2a, including the entrance canals 3 are strengthened on lower side 1b, so that they also form a strengthened region, similar to supporting ribs 6. The supporting recesses 5 are in the shape of integrally cast, essentially cylindrical borings, into which the first ends of carrier rods can be introduced.

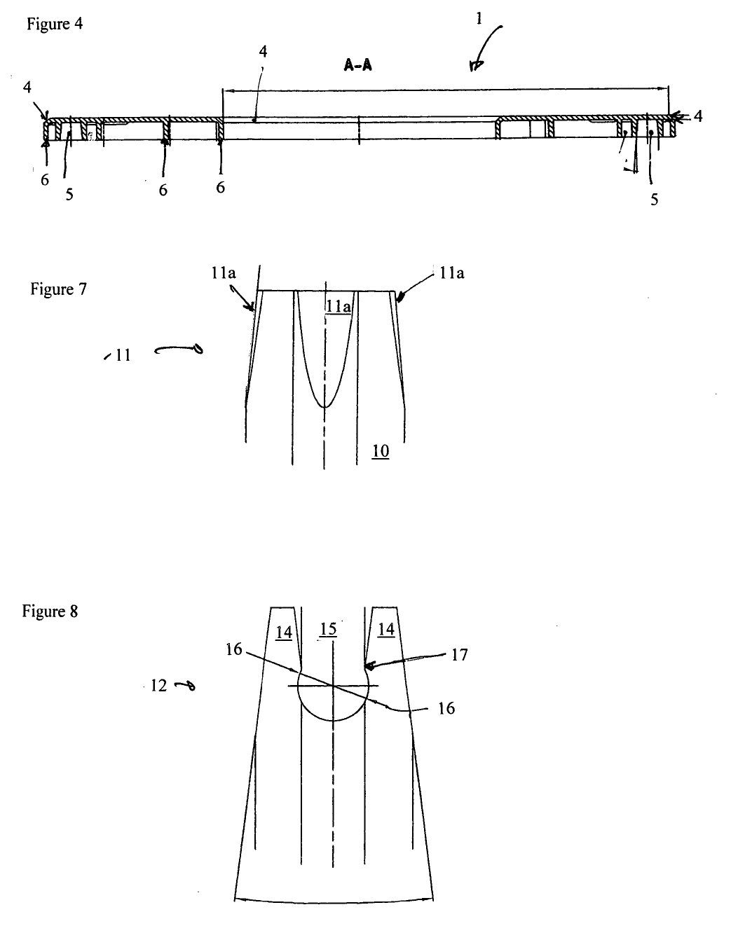

In FIG. 4 it is shown that the supporting recesses 5 in a preferred embodiment are formed in the shape of a frustrum with an opening angle of 1 to 10 degrees, preferably 5 degrees. Alternatively, the inner circular surface of supporting recesses 5 can be provided with a cylindrical and frustrum-shaped female thread, respectively.

It is preferred that the holding recesses 2 are arranged in equal distances on a concentric circle on the base plate, especially in a distance from 3 to 7 cm, especially 4 to 5 cm, measured between the geometrical centers of holding recesses 2. The diameter of the C-shaped holding recesses 2, 2a is to be proportioned such that the stem of usual glasses can be received spaciously, e.g. with a diameter of from 1 to 2 or 3 cm. The bevel preferably has 45 degrees with a dimension in its slope of 1 to 5 mm, preferably 2.5 mm. For clarification it is to be noted that the embodiment, in which the rim regions of base plate 1, holding recesses 2, 2a, supporting recesses 5, optionally entrance canals 3 and central opening 7 are formed from rod-shaped metal, e.g. wire having a circular cross-section, can be designed such as it is depicted by the double lines shown in FIG. 1. Therein, the double lines at least partially demonstrate the arrangement and forming of the wire.

FIG. 5 generally shows a carrier rod 10 having a first end 11 and a second end 12. The first end 11 serves for insertion into the supporting recesses 5 of the base plate 1, the second end 12 serves for fixation of the carrier rod e.g. to a basket for dishes of a dishwasher.

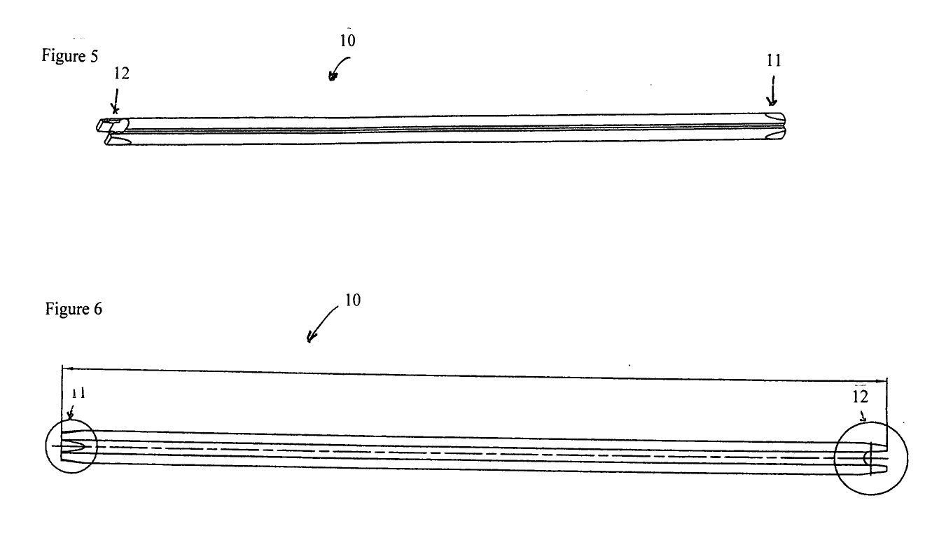

FIG. 6 shows the carrier rod 10 in longitudinal cross-section and the arrangement of the first end 11 and of the second end 12. The cross-section of the carrier rod 10 can be chosen freely, e.g. as circular profile, a square profile or cross-section profile. The first end 11, shown in FIG. 7, shows a frustrum-shaped narrowing of the carrier rod 10 so that a frictional fit connection to the supporting recess 5 can be achieved when inserting the first end 11 therein. Depicted here is a cross-section profile of carrier rod 10, so that the conical narrowing of its first end 11 essentially relates to edge faces 11a.

FIG. 8 shows a simple clamping device on the second end 12 of carrier rod 10, wherein here two opposite resilient elements 14 form a funnel-shaped recess 15, extending in axial direction of carrier rod 10. The funnel-shaped recess 15 ends in a boring 16 that is arranged perpendicularly to the axis of carrier rod 10, so that the inner surfaces of the funnel-shaped recess 15 run into the inner surface of boring 16 and between them form a region of reduced diameter 17. Such a second end 12 of a carrier rod 10 can be fastened to the wire basket of the dishwasher in a simple manner by pushing the funnel-shaped recess 15 over a region of the wire basket such that the latter slides through the funnel-shaped recess 15 into boring 16. The region of restricted diameter 17 between the funnel-shaped recess 15 and boring 16 ensures that a certain force needs to be exerted to create or loosen a connection.

It is preferred that at least three carrier rods 10, preferably four to six carrier rods 10 are connected to the recesses 5 of a base plate 1 by their respective first ends 11 and fixed to the wire basket of a dishwasher by their respective second ends 12.

### LIST OF REFERENCE NUMERALS

base plate 1
upper side of base plate 1a
lower side of base plate 1b
holding recess 2, 2a
entrance canal 3
bevel 4
supporting recess 5
supporting rib 6
central opening 7
access region 8
carrier rod 10
first end of carrier rod 11
edge face of carrier rod 11a
second end of carrier rod 12,
narrowing 13
resilient element 14
funnel-shaped recess 15
boring 16
region of restricted diameter 17

1. Holding device for glasses, which can be arranged in dishwashers, comprising a base plate (1) having an upper side (1a) and a lower side (1b) having at least one carrier opening (5) for receiving carrier rods (10), wherein the base plate (1) has at least one C-shaped holding recess (2, 2a), which is accessible from the outer circumferential line of the base plate (1) by an access region (8) and which has a larger diameter than the inner width of the access region (8), characterized in that at least one of the C-shaped holding recesses (2a) has an essentially larger diameter than other holding recesses (2), wherein at least one holding recess (2) of a smaller diameter is accessible with its access region (8) from the holding recess of larger diameter (2a).

2. Holding device according to claim 1, characterized by an entrance canal (3), arranged between the access region (8) of the C-shaped holding recess (2, 2a) and the circumferential line of the base plate (1) and which has a smaller inner width than the diameter of the holding recesses (2, 2a).

3. Holding device according to claim 1, characterized in that at least three supporting recesses (5) are present, which are arranged on the lower side (1b) of the base plate (1).

4. Holding device according to claim 3, characterized in that the support openings (5) are tapered in the shape of a frustrum.

5. Holding device according to claim 1, characterized by a bevel (4) on the upper side (1a) of the base plate (1), which is arranged around holding recesses (2, 2a).

6. Holding device according to claim 1, characterized in that the base plate (1) describes a circular plane around a central opening (7).

7. Holding device according to claim 6, characterized in that holding recesses (2) are accessible through their access regions (8) from the central opening (7).

8. Holding device according to claim 1, characterized in that carrier rods (10) having a first end (11) engage with supporting recesses (5) and which are engageable with regions of a basket of a dishwasher through a second end (12).

9. Holding device according to claim 8, characterized in that the carrier rods (10) on their second end (12) have two opposite resilient elements (14), delimiting between them a funnel-shaped recess (15) with a boring (16), which is accessible through a region of reduced diameter (17), which runs perpendicularly to the longitudinal axis of the carrier rod (10).

10. Holding device according to claim 1, characterized in that the lower side (1b) of the base plate (1) is provided with supporting ribs (6).

11. Holding device according to claim 1, characterized in that the base plate (1) consists of wire that forms the circumferential line of the base plate (1), the circumferential lines of the holding recesses (2, 2a) and the circumferential lines of the supporting recesses (5) and connects these to each other.

12. Device for cleaning glasses, characterized by a holding device according to claim 1.
